(19) United States
(12) Patent Application Publication
(10) Pub. No.: US 2016/0065791 A1
(43) Pub. Date: Mar. 3, 2016

(54) SOUND IMAGE PLAY METHOD AND APPARATUS

(71) Applicant: HUAWEI TECHNOLOGIES CO., LTD., Shenzen (CN)

(72) Inventors: Xinxin LI, Shenzhen (CN); Xu CHEN, Shenzhen (CN)

(21) Appl. No.: 14/837,711

(22) Filed: Aug. 27, 2015

(30) Foreign Application Priority Data
Aug. 29, 2014 (CN) 201410438159.1

(51) Int. Cl. H04N 5/04; H04N 9/802; H04S 7/00

(52) U.S. Cl. CPC H04N 5/04; H04S 7/30; H04N 9/802; H04S 2400/11

(57) ABSTRACT

A sound image play method and apparatus, which relate to the field of multimedia, and can reproduce original stereo effects of any quantity of sound images corresponding to an image. A specific solution is: acquiring image position information; acquiring a sound channel information set according to the image position information; and playing a sound image in accordance with the sound channel information set. The embodiments of the present invention are used for sound image play.

### CROSS-REFERENCE TO RELATED APPLICATION

This application claims priority to Chinese Patent Application No. 201410438159.1, filed on Aug. 29, 2014, which is hereby incorporated by reference in its entirety.

### TECHNICAL FIELD

The present invention relates to the field of multimedia, and in particular, to a sound image play method and apparatus.

### BACKGROUND

As living standards of people continuously improve, requirements for playing audio and video files are accordingly growing, and thereby different sorts of sound image play apparatuses appear. One of the main functions of a sound image play apparatus is to play a sound image in an audio and video file. For example, by using a sound image play apparatus such as a television set as an example, in order to play a sound image in an audio and video file, two loudspeakers are disposed under screens for most conventional television sets; and the loudspeakers are disposed on both sides of screens for some conventional television sets. For a television set for which two loudspeakers are disposed under the screen, when the screen is increasingly large, audience obviously feel that the sound comes from a central part under the screen, which weakens an original stereo effect of a sound image corresponding to an image. However, for a television set for which loudspeakers are mounted on two sides of and under the screen, stereo location is one-dimensional, only left and right sounds can be effectively distinguished, and a capability of distinguishing upper and lower sounds is weak. This defect is more obvious on an increasingly popular large-screen television set.

For the defect that a conventional sound image play apparatus easily weakens an original stereo effect of a sound image corresponding to an image, some technical solutions are generated, one of which is to arrange, around a display, sliding-type loudspeakers that use a guide rail, and control, according to a position of a main sound source in a picture of the display, the loudspeakers to move. That positions of the loudspeakers that play the sound image correctly correspond to the position of the main sound source in the picture of the display is implemented, authentically reproducing the original stereo effect of the sound image corresponding to the image. However, moving the loudspeakers according to image positions by using the guide rail causes a sound image play apparatus to be complex in the structure, have a high requirement for component flexibility and material durability, be high in costs, and be low in feasibility.

Another technical solution is to control sound production of loudspeakers above, under, to the left of, and to the right of the displaying plane according to sound image position information of the main sound source that is parsed from audio information, reproducing the original stereo effect of the sound image corresponding to the image. However, for the technology of carrying, by the audio information, the sound image position information, there is no common standard, and in addition, not all audio information carries the sound image position information, and therefore this technology is not applicable to the play of all audio and video files. In addition, in this solution, only one single sound image can be played, and multiple sound images cannot be simultaneously played; and therefore a quantity of application scenarios in which this solution can reproduce the original stereo effect of the sound image corresponding to the image is more limited.

An existing technical solution needs to reproduce the original stereo effect of the sound image corresponding to the image by using a complex mechanical structure and technical solution; or requires the audio information to carry the sound image position information, and can only reproduce the stereo effect of a single sound image; and neither is beneficial for technology promotion.

### SUMMARY

Embodiments of the present invention provide a sound image play method and apparatus, which can reproduce original stereo effects of any quantity of sound images corresponding to an image without requiring a complex mechanical structure and technical solution and without requiring audio information to carry sound image position information, and are beneficial for technology promotion.

To achieve the foregoing objectives, the embodiments of the present invention use the following technical solutions:

According to a first aspect, a sound image play method is provided, including:

acquiring image position information, where the image position information corresponds to one image in at least one image, and the image position information is used to indicate a spatial position, which is in a first frame picture, of the image corresponding to the image position information;

acquiring a sound channel information set according to the image position information, where the sound channel information set includes at least one piece of sound channel information, each piece of sound channel information in the at least one piece of sound channel information corresponds to one sound channel in at least one sound channel, and the sound channel information set corresponds to the image position information; and

playing a sound image in accordance with the sound channel information set, where the sound image corresponds to the image.

With reference to the first aspect, in a first possible implementation manner, before the acquiring image position information, the method further includes:

acquiring first frame picture data of the first frame picture; and

the acquiring image position information specifically includes:

identifying the image position information from the first frame picture according to the first frame picture data.

With reference to the first aspect or the first possible implementation manner, in a second possible implementation manner, before the playing a sound image in accordance with the sound channel information set, the method further includes:

acquiring sound image data of the sound image; and

the playing a sound image in accordance with the sound channel information set specifically includes:

playing the sound image according to the sound image data and in accordance with the sound channel information set.

With reference to the first aspect and the second possible implementation manner, in a third possible implementation manner, before the acquiring sound image data of the sound image, the method further includes:

acquiring first frame audio data of a first frame audio, where the first frame audio corresponds to the first frame picture; and

the acquiring sound image data of the sound image specifically includes:

identifying the sound image data of the sound image from the first frame audio data.

With reference to the first aspect and the second or the third possible implementation manner, in a fourth possible implementation manner, the first frame picture includes at least two images, and the at least two images include a first image and a second image, where the first image corresponds to a first sound image, and the second image corresponds to a second sound image; and

the playing a sound image in accordance with the sound channel information set specifically includes:

playing the first sound image in accordance with the first sound channel information set; and

playing the second sound image in accordance with the second sound channel information set.

With reference to the first aspect and the fourth possible implementation manner, in a fifth possible implementation manner, the first image corresponds to first image position information, the second image corresponds to second image position information, the first image position information corresponds to the first sound channel information set, and the second image position information corresponds to the second sound channel information set; and

the playing a sound image in accordance with the sound channel information set specifically includes:

acquiring a coincident sound channel information set according to the first sound channel information set and the second sound channel information set, where sound channel information in the coincident sound channel information set is included in both the first sound channel information set and the second sound channel information set; and

playing the first sound image and the second sound image according to a preset rule and in accordance with the coincident sound channel information set.

With reference to the first aspect or the fifth possible implementation manner, in a sixth possible implementation manner, before the playing the first sound image and the second sound image according to a preset rule and in accordance with the coincident sound channel information set, the method further includes:

acquiring first sound image data and second sound image data, where the first sound image data corresponds to the first sound image, and the second sound image data corresponds to the second sound image; and

mixing the first sound image data and the second sound image data, to obtain coincident sound image data; and

the playing the first sound image and the second sound image according to a preset rule and in accordance with the coincident sound channel information set specifically includes:

playing the first sound image and the second sound image according to the coincident sound image data and in accordance with the coincident sound channel information set.

With reference to the first aspect and any one of the fourth to sixth possible implementation manners, in a seventh possible implementation manner, before the playing the first sound image in accordance with the first sound channel information set, the method further includes:

acquiring a first differentiating sound channel information set according to the first sound channel information set and the second sound channel information set, where sound channel information in the first differentiating sound channel information set is included in the first sound channel information set but is not included in the second sound channel information set; and

the playing the first sound image in accordance with the first sound channel information set specifically includes:

playing the first sound image in accordance with the first differentiating sound channel information set.

With reference to the first aspect or any one of the first to seventh possible implementation manners, in an eighth possible implementation manner, the method is applied to a sound image play apparatus, and the sound image play apparatus includes at least one loudspeaker, where each loudspeaker in the at least one loudspeaker corresponds to one sound channel in the at least one sound channel; and

the playing a sound image in accordance with the sound channel information set specifically includes:

driving, in accordance with the sound channel information set, the at least one loudspeaker to play the sound image.

According to a second aspect, a sound image play apparatus is provided, including:

an acquiring unit, configured to acquire image position information, where the image position information corresponds to one image in at least one image, and the image position information is used to indicate a spatial position, which is in a first frame picture, of the image corresponding to the image position information;

a channel unit, configured to acquire a sound channel information set according to the image position information acquired by the acquiring unit, where the sound channel information set includes at least one piece of sound channel information, each piece of sound channel information in the at least one piece of sound channel information corresponds to one sound channel in at least one sound channel, and the sound channel information set corresponds to the image position information; and

a play unit, configured to play a sound image in accordance with the sound channel information set acquired by the channel unit, where the sound image corresponds to the image.

With reference to the second aspect, in a first possible implementation manner, the acquiring unit is further configured to acquire first frame picture data of the first frame picture; and

that the acquiring unit is configured to acquire image position information specifically includes that:

the acquiring unit is configured to identify the image position information from the first frame picture according to the first frame picture data acquired by the acquiring unit.

With reference to the second aspect or the first possible implementation manner, in a second possible implementation manner, the acquiring unit is further configured to acquire sound image data of the sound image; and

that the play unit is configured to play a sound image in accordance with the sound channel information set acquired by the channel unit specifically includes that:

the play unit is configured to play the sound image according to the sound image data acquired by the acquiring unit and in accordance with the sound channel information set.

With reference to the second aspect and the second possible implementation manner, in a third possible implementation manner, the acquiring unit is further configured to acquire first frame audio data of a first frame audio, where the first frame audio corresponds to the first frame picture; and

that the acquiring unit is further configured to acquire sound image data of the sound image specifically includes that:

the acquiring unit is configured to identify the sound image data of the sound image from the first frame audio data acquired by the acquiring unit.

With reference to the second aspect and the second or the third possible implementation manner, in a fourth possible implementation manner, the first frame picture includes at least two images, and the at least two images include a first image and a second image, where the first image corresponds to a first sound image, and the second image corresponds to a second sound image; and

that the play unit is configured to play a sound image in accordance with the sound channel information set acquired by the acquiring unit specifically includes that:

the play unit is specifically configured to play the first sound image in accordance with the first sound channel information set acquired by the acquiring unit; and

the play unit is further specifically configured to play the second sound image in accordance with the second sound channel information set acquired by the acquiring unit.

With reference to the second aspect and the fourth possible implementation manner, in a fifth possible implementation manner, the first image corresponds to first image position information, the second image corresponds to second image position information, the first image position information corresponds to the first sound channel information set, and the second image position information corresponds to the second sound channel information set; and

the play unit includes:

a coincident channel subunit, configured to acquire a coincident sound channel information set according to the first sound channel information set and the second sound channel information set that are acquired by the channel unit, where sound channel information in the coincident sound channel information set is included in both the first sound channel information set and the second sound channel information set; and

a coincident play subunit, configured to play the first sound image and the second sound image according to a preset rule and in accordance with the coincident sound channel information set acquired by the coincident channel subunit.

With reference to the second aspect and the fifth possible implementation manner, in a sixth possible implementation manner, the play unit further includes:

an acquiring subunit, configured to acquire first sound image data and second sound image data, where the first sound image data corresponds to the first sound image, and the second sound image data corresponds to the second sound image; and

a mixing subunit, configured to mix the first sound image data and the second sound image data that are acquired by the acquiring subunit, to obtain coincident sound image data; and

the coincident play subunit is specifically configured to play the first sound image and the second sound image according to the coincident sound image data acquired by the mixing subunit and in accordance with the coincident sound channel information set acquired by the coincident channel subunit.

With reference to the second aspect and any one of the fourth to sixth possible implementation manners, in a seventh possible implementation manner, the play unit further includes:

a differentiating channel subunit, configured to acquire a first differentiating sound channel information set according to the first sound channel information set and the second sound channel information set, where the at least one piece of first sound channel information includes the first differentiating sound channel information set, and the at least one piece of second sound channel information does not include any first differentiating sound channel information in the first differentiating sound channel information set; and

a differentiating play subunit, configured to play the first sound image in accordance with the first differentiating sound channel information set acquired by the differentiating channel subunit.

With reference to the second aspect or any one of the first to seventh possible implementation manners, in an eighth possible implementation manner, the sound image play apparatus further includes at least one loudspeaker, where each loudspeaker in the at least one loudspeaker corresponds to one sound channel in the at least one sound channel; and

that the play unit is configured to play a sound image in accordance with the sound channel information set acquired by the channel unit specifically includes that:

the play unit is configured to drive, in accordance with the sound channel information set acquired by the channel unit, the at least one loudspeaker to play the sound image.

According to the sound image play method and apparatus provided in the embodiments of the present invention, image position information may be acquired, a sound channel information set may be acquired in accordance with a preset rule and according to the image position information, and a sound image may be played in accordance with the sound channel information set, where the image position information is used to indicate a spatial position, which is in a first frame picture, of an image corresponding to the image position information, the sound channel information set includes at least one piece of sound channel information, the sound channel information corresponds to one sound channel, and the sound image corresponds to the image. Such a solution is simple, and does not need a complex mechanical structure and technical solution, and a sound channel information set may be acquired in a manner of acquiring image position information, so that a sound image can be played in a common sound channel manner, and therefore original stereo effects of any quantity of sound images corresponding to an image can be reproduced without requiring audio information to carry sound image position information. This solution may be used to play any audio and video file, and therefore, the present invention is beneficial for technology promotion.

### BRIEF DESCRIPTION OF DRAWINGS

To describe the technical solutions in the embodiments of the present inventionmore clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a sound image play method according to an embodiment of the present invention;

FIG. 2 is a schematic flowchart of a sound image play method according to another embodiment of the present invention;

FIG. 3 is a schematic explanatory diagram of a sound image play method according to still another embodiment of the present invention;

FIG. 4 is a schematic structural diagram of a sound image play apparatus according to an embodiment of the present invention;

FIG. 5 is a schematic structural diagram of another sound image play apparatus according to an embodiment of the present invention;

FIG. 6 is a schematic structural diagram of still another sound image play apparatus according to an embodiment of the present invention;

FIG. 7 is a schematic structural diagram of yet another sound image play apparatus according to an embodiment of the present invention;

FIG. 8 is a schematic structural diagram of still yet another sound image play apparatus according to an embodiment of the present invention; and

FIG. 9 is a schematic structural diagram of a sound image play apparatus according to another embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

For clearly describing the technical solutions in the embodiments of the present invention clearly, in the embodiments of the present invention, same items or similar items whose functions and roles are basically the same are differentiated by using words such as “first” and “second”. A person skilled in the art may understand that the words such as “first” and “second” are not limiting a quantity and an execution sequence.

Specific meanings of an image, a sound image, an audio, and a picture that are used in the embodiments of the present invention may be as follows: 1. the image is an image of an object, for example, an image of a person, an image of an animal, and an image of an automobile; 2. the sound image is a sound that includes a stereo effect, and the effect reflected by such a sound may be seen as a “sound picture”; 3. the audio is a specialized name of the sound, and in a multimedia field, is mostly similar to a video, and carries sound data in the unit of frames; and 4. the picture is, in the present invention, a color representation form that has a manually set fixed boundary, and may be a frame of a video picture in a video file.

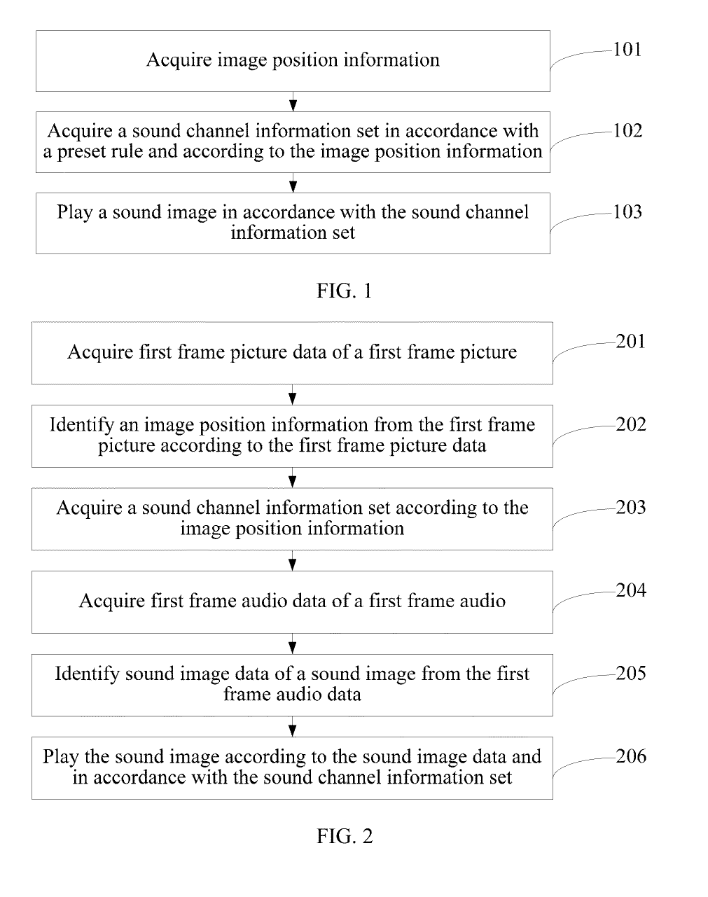

An embodiment of the present invention provides a sound image play method, which may be used in a multimedia field, and specifically may be used for sound image play. Referring to FIG. 1, the method may include the following steps:

101: Acquire image position information.

The image position information corresponds to one image in at least one image, and the image position information may be used to indicate a spatial position, which is in a first frame picture, of the image corresponding to the image position information.

Specifically, the image position information may be acquired through identification from a to-be-processed picture, or may be acquired from stored image position information, where the acquired image position information may belong to multiple images.

102: Acquire a sound channel information set in accordance with a preset rule and according to the image position information.

Optionally, the method may further include the following steps:

103: Play a sound image in accordance with the sound channel information set.

The sound channel information set may include at least one piece of sound channel information, each piece of sound channel information in the at least one piece of sound channel information corresponds to one sound channel in at least one sound channel, the sound channel information set corresponds to the image position information, and the sound image corresponds to the image.

Specifically, when this embodiment of the present invention is applied to an apparatus, it may be that the apparatus to which the method provided in this application embodiment is applied plays the corresponding sound image in accordance with the sound channel information set, and it may also be that the sound channel information set is transmitted to a peripheral that specially plays a sound image, to acquire and send the at least one sound channel information set to control the play of the at least one sound image.

A benefit of this is that audio information is not required to carry sound image position information. It may be known from the foregoing that there is no common standard for the audio information to carry the sound image position information. In addition, a stereo effect of a sound image may be reproduced in combination with a currently very mature sound channel technology according to the acquired sound channel information, without requiring a complex structure and technical solution.

According to the sound image play method provided in this embodiment of the present invention, image position information may be acquired, and a sound channel information set may be acquired in accordance with a preset rule and according to the image position information, so as to play a sound image in accordance with the sound channel information set, where the image position information may be used to indicate a spatial position, which is in a first frame picture, of an image corresponding to the image position information, the sound channel information set may include at least one piece of sound channel information, the sound channel information corresponds to one sound channel, and the sound image corresponds to the image. Such a solution is simple, and does not need a complex mechanical structure and technical solution, and a sound channel information set may be acquired in a manner of acquiring image position information, so that a sound image can be played in a common sound channel manner, and therefore original stereo effects of any quantity of sound images corresponding to an image can be reproduced without requiring audio information to carry sound image position information. This solution may be used to play any audio and video file, and therefore, the present invention is beneficial for technology promotion.

On the basis of the sound image play method provided in the foregoing embodiment of the present invention, this embodiment of the present invention provides a sound image play method, which may be used in the multimedia field, and specifically may be used for sound image play. Referring to FIG. 2, the method may include the following steps:

201: Acquire first frame picture data of a first frame picture.

The first frame picture may be any frame of a video picture in a to-be-processed audio and video file.

202: Identify the image position information from the first frame picture according to the first frame picture data.

Specifically, the method may be as follows: acquiring at least one piece of image feature information, where each piece of image feature information in the at least one piece of image feature information corresponds to one image in the at least one image, where, the at least one image may include a first image, and the at least one image may further include a second image; and acquiring the image position information according to the first frame picture data and the at least one piece of image feature information.

This step is one of specific implementation manners of the “acquiring image position information”.

The image position information corresponds to one image in at least one image, the image position information may be used to indicate a spatial position, which is in the first frame picture, of the image corresponding to the image position information, and the first frame picture may include at least two images, including the first image and the second image; and the first image corresponds to first image position information, and the second image corresponds to second image position information.

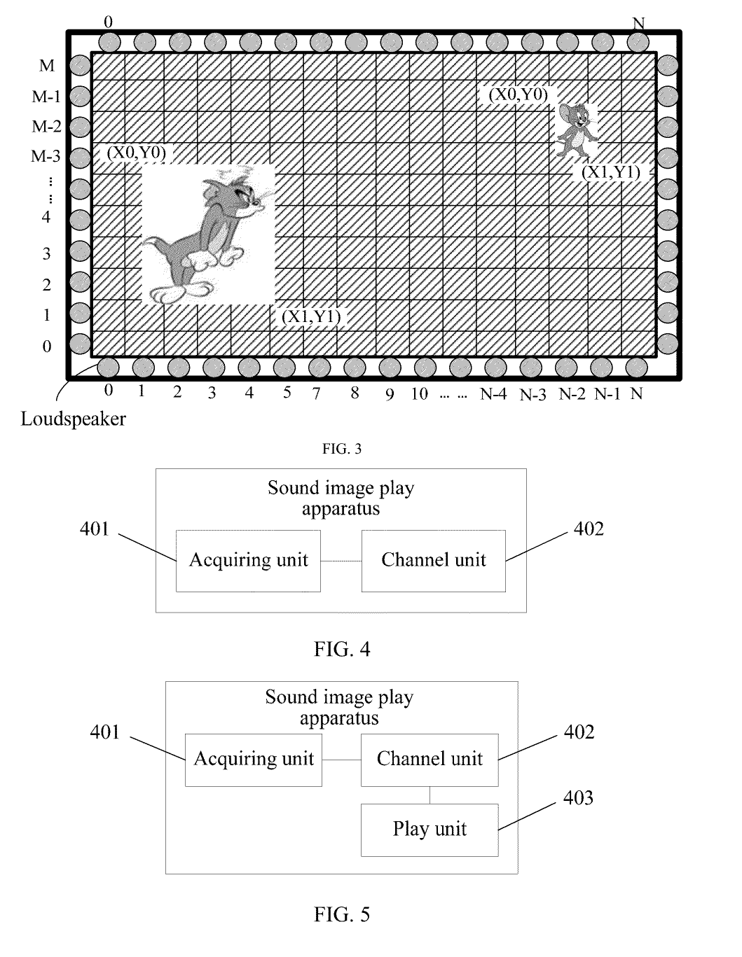

Specifically, referring to FIG. 3, for example, in FIG. 3, there are a display screen (which is the shadow portion), images in the screen (the cat on the bottom left and the mouse on the top right), and loudspeakers surrounding the screen. A process of implementing step 202 may be in the following manner:

For example, it is assumed that in the figure, the image on the bottom left is the first image, and the image on the top right is the second image.

The image position information of the at least one image is identified by using an image pattern recognition technology. Currently, there are multiple types of image pattern recognition technologies in the industry, and common ones are color visual property and color similarity measurement, an image detection technology based on impulse noise detection, and an image fuzzy classification technology based on a BP (Back Propagation, back propagation) neural network. These image pattern recognition technologies can all be used to identify the at least one image in combination with the at least one piece of image feature information, thereby obtaining at least one piece of image position information.

By using an image pattern recognition technology, positions of multiple image blocks in a current picture may be automatically identified in real time for simplified processing, and in this case, each piece of image position information in the at least one image position information may be described by using rectangular coordinates, for example: (X0, Y0) indicates coordinates on the top left, and (X1, Y1) indicates coordinates on the bottom right. Coordinate values corresponding to X0, Y0, X1, and Y1 may be pixel coordinate values in a first frame picture, or may be flexibly set, for example, coordinate values may be set according to corresponding loudspeakers, and one coordinate value corresponds to a pixel coordinate value range.

As shown in the figure, first image position information (X0, Y0, X1, Y1) of the first image, and second image position information (X0, Y0, X1, Y1) of the second image are shown.

Certainly, the spatial position, which is in the first frame picture, of the image may also be represented by using image position information in another manner.

Optionally, after the image position information is identified, in order to improve processing performance, if a feature of a same image block in consecutive multiple frames of pictures changes slightly, with only a change of position movement, position information of the image block may be quickly identified by using a motion image detection technology. There are also multiple types of mature implementation solutions for the motion image detection technology, and common ones are motion image detection based on a frame difference method and motion image detection based on a background modeling technology.

A benefit of this is that image position information corresponding to each identified image may be obtained, which is beneficial for subsequent reproduction of a stereo effect of a sound image corresponding to the image.

After the image position information is acquired in this step:

203: Acquire the sound channel information set according to the image position information.

The sound channel information set may include at least one piece of sound channel information, each piece of sound channel information in the at least one piece of sound channel information corresponds to one sound channel in at least one sound channel, the sound channel information set corresponds to the image position information, and the sound image corresponds to the image.

When this embodiment of the present invention is applied to an apparatus, it may be that the apparatus to which the method provided in this application embodiment is applied plays the corresponding sound image in accordance with the sound channel information set, and it may also be that the sound channel information set is transmitted to a peripheral that specially plays a sound image, to acquire and send the at least one sound channel information set to control the play of the at least one sound image.

A benefit of this is that, a stereo effect of a sound image may be reproduced in combination with a currently very mature sound channel technology according to the acquired sound channel information, without requiring a complex structure and technical solution.

The first image corresponds to a first sound image, the second image corresponds to a second sound image, the first image corresponds to first image position information, the second image corresponds to second image position information, the first image position information corresponds to a first sound channel information set, and the second image position information corresponds to a second sound channel information set.

For a specific implementation manner, reference may be made to FIG. 3:

For example, a space to which the first sound image needs to correspond may be obtained according to the first image position information (X0, Y0, X1, Y1) of the first image acquired from the first frame picture, and accordingly a sound channel corresponding to a loudspeaker unit that needs to produce a sound may be calculated, so as to control the loudspeaker to produce a sound.

In this case, coordinates corresponding to loudspeakers (0-N) above and under the screen may be used as horizontal coordinates for reference, and coordinates corresponding to loudspeakers (0-M) to the left of and to the right of the screen may be used as vertical coordinates for reference; the space (X0, Y0, X1, Y1) indicated by the first image position information is shown in FIG. 3; therefore, in order to reproduce a stereo effect of the first sound image, loudspeakers that are to the left of and to the right of the screen and are corresponding to the position (X0-X1) may need to produce a sound; and loudspeakers that are above and under the screen and are corresponding to the position (Y0-Y1) may also need to produce a sound.

Therefore, in this case, the first sound channel information set is generated according to the first image position information, and the first sound channel information set includes at least one piece of first sound channel information, where each piece of first sound channel information in the at least one piece of first sound channel information individually corresponds to one sound channel, and these sound channels corresponding to the first sound channel information correspond to the loudspeakers that need to produce a sound.

The foregoing description is only a solution for calculating the sound channel information set, and specifically, corresponding calculation relationships between image position information and a sound channel, sound channel information, and a sound channel information set may be adjusted according to an actual case, so as to be beneficial for achieving a stereo that meets an environment requirement, thereby reproducing the stereo effect of the sound image.

204: Acquire first frame audio data of a first frame audio.

The first frame audio corresponds to the first frame picture.

205: Identify sound image data of the sound image from the first frame audio data.

Specifically, the method may be as follows: acquiring at least one piece of sound image feature information, where each piece of sound image feature information in the at least one piece of sound image feature information corresponds to one sound image in the at least one sound image; and acquiring at least one piece of sound image data according to the first frame audio data and the at least one piece of sound image feature information, where each piece of sound image data in the at least one piece of sound image data corresponds to one piece of sound image feature information in the at least one piece of sound image feature information.

Specifically, a specific type of a sound production sound image may be identified through sound image feature identification; for example, the sound image is identified by using a voiceprint recognition technology, which is a mature technology. After that, a correspondence between a sound image and an image may be obtained by matching an identified sound image type with a specific picture type of the corresponding image identified by using an image feature; or a matching relationship between the two may be preset, for example: it is set that each piece of image feature information in the at least one piece of image feature information corresponds one-to-one to each piece of image feature information in the at least one piece of sound image feature information.

Step 204 and step 205 may be seen as a specific implementation manner of the following step A01:

A01: Acquire sound image data of a sound image.

Each piece of sound image data in the at least one piece of sound image data corresponds to one sound image in the at least one sound image.

Specifically, when the sound image data is not differentiated in advance in the audio information, step 204 and step 205 may be performed; or if the at least one piece of sound image data has been differentiated in advance, step A01 may be directly performed.

Herein it should be noted that there is a sequence for step 201 to step 203, and there is a sequence for step 204 and step 205; however, there is no sequence between two step groups, which are step 201 to step 203, and step 204 and step 205.

206: Play the sound image according to the sound image data and in accordance with the sound channel information set.

It should be noted that, when the method provided in this embodiment of the present invention is applied to a device or an apparatus, on one hand, it may be that the device and the apparatus, to which the method is applied, acquire, store, parse, and decode sound image data, to play a sound image; and in this case, the foregoing steps are performed.

On the other hand, specific sound image data corresponding to each sound image in the at least one sound image may be stored, parsed, and played by using a peripheral, and for the step of playing the sound image in accordance with the sound channel information set, it only needs to control the peripheral to play the sound image corresponding to the image in accordance with the at least one piece of sound channel information.

In this case, optionally, step B01 may be directly performed without performing the foregoing step 204 to step 206:

B01: Play a sound image in accordance with the sound channel information set.

Specifically, specific implementation manners for the foregoing step of “playing a sound image in accordance with the sound channel information set” in this embodiment of the present invention may include the following several manners, where the implementation manners may exist independently, and may also coexist:

A first implementation manner is as follows:

The at least one image may include a first image, the first image position information may include first image position information, the at least one sound image may include a first sound image, the at least one sound channel information set may include a first sound channel information set, the first sound channel information set may include at least one piece of first sound channel information, and the first image corresponds to the first image position information, the first sound image and the first sound channel information set; and

In this case, the playing a sound image in accordance with the sound channel information set specifically may include the following step C01:

C01: Play the first sound image in accordance with the first sound channel information set.

Specifically, with reference to the foregoing steps in this embodiment of the present invention, it may be known that this step specifically may be: playing the first sound image in accordance with the first sound channel information set and according to first sound image data.

The first sound image data is included in the at least one piece of sound image data, and the first sound image data corresponds to the first sound image.

A second implementation manner may coexist with the first implementation manner.

The at least one image may further include a second image, the first image position information may further include second image position information, the at least one sound image may further include a second sound image, the at least one sound channel information set may further include a second sound channel information set, the second sound channel information set may include at least one piece of second sound channel information, and the second image corresponds to the second image position information, the second sound image and the second sound channel information set.

In this case, the playing a sound image in accordance with the sound channel information set may further include the following step C02:

C02: Play the second sound image in accordance with the second sound channel information set.

Specifically, with reference to the foregoing steps in this embodiment of the present invention, it may be known that this step specifically may be: playing the second sound image in accordance with the second sound channel information set and according to second sound image data.

The second sound image data is included in the at least one piece of sound image data, and the second sound image data corresponds to the second sound image.

It may be known from the foregoing that, the first implementation manner and the second implementation manner in this embodiment of the present invention are both applicable to play of a single sound image, and when combined, the two may implement simultaneous play of two sound images. This embodiment of the present invention is only an example of this method, and in practice, the first and the second are not fixed. Through the combination of the first and the second implementation manners in this embodiment of the present invention, this method may be enabled to implement simultaneous play of any quantity of sound images.

A third implementation manner: this implementation manner is established on the basis of the combination of the foregoing first and second implementation manners in this embodiment.

In this case, the playing a sound image in accordance with the sound channel information set may further include the following step C031 and step C032:

C031: Obtain a coincident sound channel information set according to the first sound channel information set and the second sound channel information set.

Sound channel information in the coincident sound channel information set is included in both the first sound channel information set and the second sound channel information set

C032: Play the first sound image and the second sound image according to a preset rule and in accordance with the coincident sound channel information set.

Specifically, with reference to the foregoing steps in this embodiment of the present invention, it may be known that this step specifically may be: playing the first sound image and the second sound image according to a preset rule, in accordance with the coincident sound channel information set, and according to the first sound image data and the second sound image data.

Specifically. the third implementation manner may be applied when the first sound channel information set and the second sound channel information set include at least one piece of same sound channel information.

For the third implementation manner, further, before step C032, the method may further include the following steps:

acquiring first sound image data and second sound image data, where the first sound image data corresponds to the first sound image, and the second sound image data corresponds to the second sound image; and mixing the first sound image data and the second sound image data, to obtain coincident sound image data. In this case, the implementation manner of step C032 specifically may include: playing the first sound image and the second sound image according to the coincident sound image data and in accordance with the coincident sound channel information set.

In this case, optionally, the implementation manner of step C032 may further include: in a sound channel corresponding to the coincident sound channel information set, one half plays the first sound image, and the other half plays the second sound image; or no sound channel corresponding to each piece of coincident sound channel information in the coincident sound channel information set plays the first sound image and the second sound image.

Herein, it should be noted that, for a sound image without a corresponding image, for example, when image position information is not detected, the sound image may be produced as a background sound, or image position information corresponding to the sound image may be acquired according to a position of the last sound production on the screen before this.

For the foregoing several implementation manners and combined implementation manners of the implementation manners, before the playing the first sound image in accordance with the first sound channel information set, the following step may be further included: acquiring a first differentiating sound channel information set according to the first sound channel information set and the second sound channel information set, where sound channel information in the first differentiating sound channel information set is included in the first sound channel information set but is not included in the second sound channel information set; and in this case, the playing the first sound image in accordance with the first sound channel information set specifically may include: playing the first sound image in accordance with the first differentiating sound channel information set.

Optionally, still referring to FIG. 3, a circle in the figure indicates a loudspeaker, the method may be applied to a sound image play apparatus, and the sound image play apparatus may include at least one loudspeaker, where each loudspeaker in the at least one loudspeaker corresponds to one sound channel in the at least one sound channel; and in this case, the playing a sound image in accordance with the sound channel information set specifically may include: driving, in accordance with the sound channel information set, the at least one loudspeaker to play the sound image.

Certainly, this method may also be applied to a sound image play apparatus that is combined with a loudspeaker in another structure. This method may be combined with an existing sound channel technology to implement play of a sound image, and therefore has extensive applicability.

Specifically, it may be that audio data input from a play source is sent to a corresponding power amplifier by using an I2S (Inter-IC Sound, inter-IC sound) bus, to drive the loudspeaker to produce a sound. A loudspeaker array that is formed by at least one loudspeaker may use a common directional loudspeaker, to produce a sound toward the direct front of the screen, thereby improving the hearing location accuracy/capability of audience. An ordinary loudspeaker may also be used. A digital power amplifier, which is configured to receive multiple 2S signals, can drive the loudspeaker.

In an actual application, the sound image play apparatus may be a television set, a big screen, or the like, or may be another audio and video sound image play apparatus, and therefore combined with the sound image play method provided in this embodiment of the present invention, the loudspeaker array that includes at least one loudspeaker can effectively reproduce an original stereo effect of a sound image.

According to the sound image play method provided in this embodiment of the present invention, image position information may be acquired from a first frame picture according to at least one piece of image feature information, and a sound channel information set may be acquired in accordance with a preset rule and according to the image position information, so that data for reproducing a stereo effect of a sound image may be identified from any audio and video file without requiring audio information to carry sound image position information, so as to reproduce a stereo effect of any quantity of sound images corresponding to an image; in addition, at least one piece of sound image data may be acquired from a first frame audio corresponding to the first frame picture according to at least one piece of sound image feature information, so as to play a sound image in accordance with the sound channel information set and according to at least one piece of sound image data. Therefore, this solution is simple, and does not need a complex mechanical structure and technical solution. In this solution, the sound image can be played in a common sound channel manner, and the present invention is beneficial for technology promotion.

Referring to FIG. 4, an embodiment of the present invention provides a sound image play apparatus, which may be applied to a multimedia field, specifically may be used in combination with the sound image play method provided in the foregoing embodiment of the present invention, and specifically includes the following content:

an acquiring unit 401, configured to acquire image position information, where the image position information corresponds to one image in at least one image, and the image position information is used to indicate a spatial position, which is in a first frame picture, of the image corresponding to the image position information; and

a channel unit 402, configured to acquire a sound channel information set according to the image position information acquired by the acquiring unit 401, where the sound channel information set includes at least one piece of sound channel information, each piece of sound channel information in the at least one piece of sound channel information corresponds to one sound channel in at least one sound channel, and the sound channel information set corresponds to the image position information.

Optionally, referring to FIG. 5, the sound image play apparatus further includes:

a play unit 403, configured to play a sound image in accordance with the sound channel information set acquired by the channel unit 402, where the sound image corresponds to the image.

Optionally, the acquiring unit 401 is further configured to acquire first frame picture data of the first frame picture; and

that the acquiring unit 401 is configured to acquire image position information specifically includes that:

the acquiring unit 401 is configured to identify the image position information from the first frame picture according to the first frame picture data acquired by the acquiring unit 401.

Optionally, the acquiring unit 401 is further configured to acquire sound image data of the sound image; and

that the play unit 403 is configured to play a sound image in accordance with the sound channel information set acquired by the channel unit 402 specifically includes that:

the play unit 403 is configured to play the sound image according to the sound image data acquired by the acquiring unit 401 and in accordance with the sound channel information set.

Further optionally, the acquiring unit 401 is further configured to acquire first frame audio data of a first frame audio, where the first frame audio corresponds to the first frame picture; and

that the acquiring unit 401 is further configured to acquire sound image data of the sound image specifically includes that:

the acquiring unit 401 is configured to identify the sound image data of the sound image from the first frame audio data acquired by the acquiring unit 401.

Further optionally, the first frame picture includes at least two images, and the at least two images include a first image and a second image, where the first image corresponds to a first sound image, and the second image corresponds to a second sound image; and

that the play unit 403 is configured to play a sound image in accordance with the sound channel information set acquired by the acquiring unit 401 specifically includes that:

the play unit 403 is specifically configured to play the first sound image in accordance with the first sound channel information set acquired by the acquiring unit 401; and

the play unit 403 is further specifically configured to play the second sound image in accordance with the second sound channel information set acquired by the acquiring unit 401.

Still further optionally, the first image corresponds to first image position information, the second image corresponds to second image position information, the first image position information corresponds to the first sound channel information set, and the second image position information corresponds to the second sound channel information set.

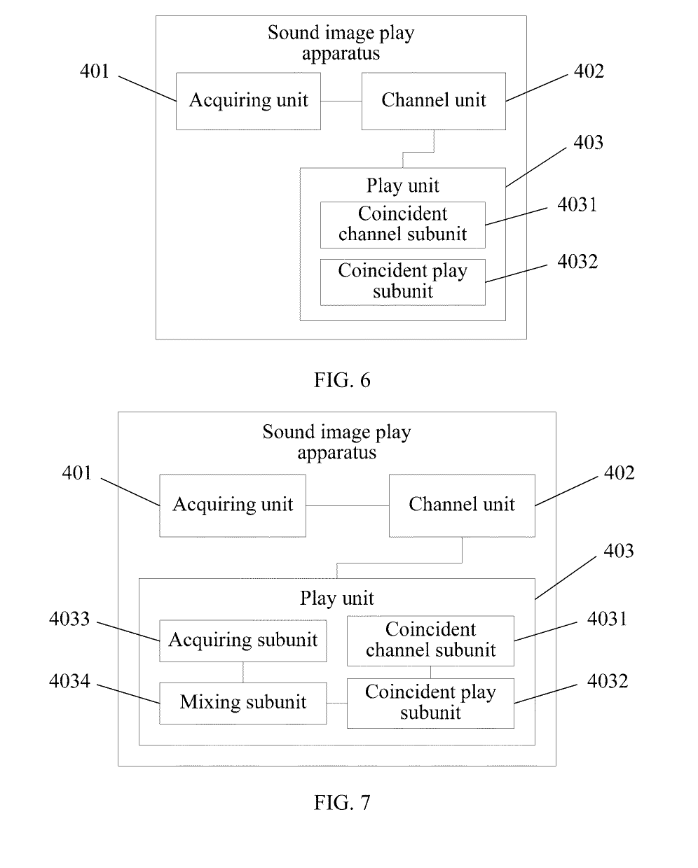

On the basis of FIG. 5, referring to FIG. 6, the play unit 403 includes:

a coincident channel subunit 4031, configured to acquire a coincident sound channel information set according to the first sound channel information set and the second sound channel information set that are acquired by the channel unit 402, where sound channel information in the coincident sound channel information set is included in both the first sound channel information set and the second sound channel information set; and

a coincident play subunit 4032, configured to play the first sound image and the second sound image according to a preset rule and in accordance with the coincident sound channel information set acquired by the coincident channel subunit 4031.

Yet further optionally, on the basis of FIG. 6, referring to FIG. 7, the play unit 403 further includes:

an acquiring subunit 4033, configured to acquire first sound image data and second sound image data, where the first sound image data corresponds to the first sound image, and the second sound image data corresponds to the second sound image; and

a mixing subunit 4034, configured to mix the first sound image data and the second sound image data that are acquired by the acquiring subunit 4033, to obtain coincident sound image data; and

the coincident play subunit 4032 is specifically configured to play the first sound image and the second sound image according to the coincident sound image data acquired by the mixing subunit 4034 and in accordance with the coincident sound channel information set acquired by the coincident channel subunit 4031.

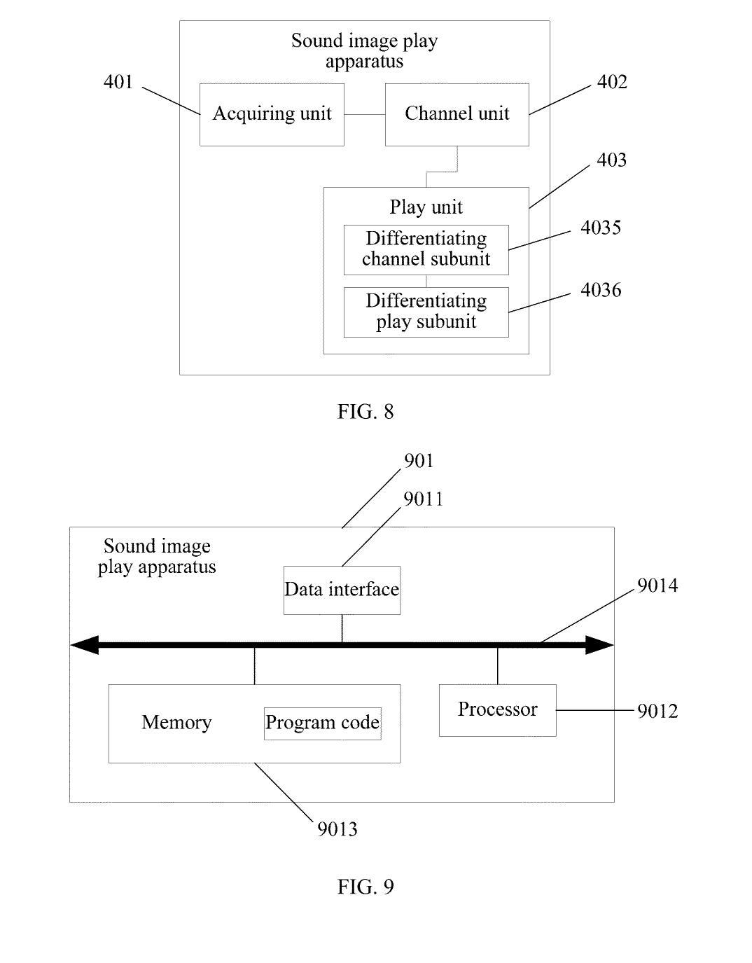

Optionally, on the basis of FIG. 5, referring to FIG. 8, the play unit 403 further includes:

a differentiating channel subunit 4035, configured to acquire a first differentiating sound channel information set according to the first sound channel information set and the second sound channel information set, where the at least one piece of first sound channel information includes the first differentiating sound channel information set, and the at least one piece of second sound channel information does not include any first differentiating sound channel information in the first differentiating sound channel information set; and

a differentiating play subunit 4036, configured to play the first sound image in accordance with the first differentiating sound channel information set acquired by the differentiating channel subunit 4035.

Optionally, the sound image play apparatus further includes at least one loudspeaker, where each loudspeaker in the at least one loudspeaker corresponds to one sound channel in the at least one sound channel; and

that the play unit 403 is configured to play a sound image in accordance with the sound channel information set acquired by the channel unit 402 specifically includes that:

the play unit 403 is configured to drive, in accordance with the sound channel information set acquired by the channel unit 402, the at least one loudspeaker to play the sound image.

According to the sound image play apparatus provided in this embodiment of the present invention, image position information may be acquired, and a sound channel information set may be acquired in accordance with a preset rule and according to the image position information, so as to play a sound image in accordance with the sound channel information set, where the image position information may be used to indicate a spatial position, which is in a first frame picture, of an image corresponding to the image position information, the sound channel information set may include at least one piece of sound channel information, the sound channel information corresponds to one sound channel, and the sound image corresponds to the image. Such a solution is simple, and does not need a complex mechanical structure and technical solution, and a sound channel information set may be acquired in a manner of acquiring image position information, so that a sound image can be played in a common sound channel manner, and therefore original stereo effects of any quantity of sound images corresponding to an image can be reproduced without requiring audio information to carry sound image position information. This solution may be used to play any audio and video file, and therefore, the present invention is beneficial for technology promotion.

An embodiment of the present invention provides a sound image play apparatus, which may be applied to a multimedia field, and specifically may be used in combination with the sound image play method provided in the foregoing embodiment of the present invention. Referring to FIG. 9, the sound image play apparatus may be embedded into or be a microcomputer, for example, a general-purpose computer, a customized computer, and a portable device such as a mobile phone terminal or a tablet computer, and the sound image play apparatus 901 may include: at least one data interface 9011, a processor 9012, a memory 9013, and a bus 9014, where the at least one data interface 9011, the processor 9012, and the memory 9013 are connected and communicate with each other by using a bus 9014.

The bus 9014 may be an ISA (Industry Standard Architecture, Industry Standard Architecture) bus, a PCI (Peripheral Component, Peripheral Component Interconnect) bus, an EISA (Extended Industry Standard Architecture, Extended Industry Standard Architecture) bus, or the like. The bus 9014 may be classified into an address bus, a data bus, a control bus, and so on; and is indicated by using only one bold line in FIG. 9 for convenience of indication, which however does not indicate that there is only one bus or one type of bus, where:

the memory 9013 may be configured to store executable program code, where the program code may include a computer instruction; and the memory 9013 may include a high speed RAM memory, and may also further include a non-volatile memory (non-volatile memory), for example, at least one magnetic disk memory.

The processor 9012 may be a central processing unit (Central Processing Unit, CPU for short), or an application specific integrated circuit (Application Specific Integrated Circuit, ASIC for short), or configured to one or more integrated circuits that implement the embodiments of the present invention.

The data interface 9011 is configured to acquire image position information, where the image position information corresponds to one image in at least one image, and the image position information is used to indicate a spatial position, which is in a first frame picture, of the image corresponding to the image position information.

The processor 9012 is configured to acquire a sound channel information set according to the image position information acquired by the data interface 9011, where the sound channel information set includes at least one piece of sound channel information, each piece of sound channel information in the at least one piece of sound channel information corresponds to one sound channel in at least one sound channel, and the sound channel information set corresponds to the image position information.

Optionally, the processor 9012 is further configured to play a sound image in accordance with the sound channel information set acquired by the processor 9012, where the sound image corresponds to the image.

Optionally, the data interface 9011 is further configured to acquire first frame picture data of the first frame picture; and

that the data interface 9011 is configured to acquire image position information, specifically includes that:

the data interface 9011 is configured to identify the image position information from the first frame picture according to the first frame picture data acquired by the data interface 9011.

Optionally, the data interface 9011 is further configured to acquire sound image data of the sound image; and

that the processor 9012 is configured to play a sound image in accordance with the sound channel information set acquired by the processor 9012 specifically includes that:

the processor 9012 is configured to play the sound image according to the sound image data acquired by the data interface 9011 and in accordance with the sound channel information set.

Further optionally, the data interface 9011 is further configured to acquire first frame audio data of a first frame audio, where the first frame audio corresponds to the first frame picture; and

that thee data interface 9011 is further configured to acquire sound image data of the sound image specifically includes that:

the data interface 9011 is configured to identify the sound image data of the sound image from the first frame audio data acquired by the data interface 9011.

Further optionally, the first frame picture includes at least two images, and the at least two images include a first image and a second image, where the first image corresponds to a first sound image, and the second image corresponds to a second sound image; and

that the processor 9012 is configured to play a sound image in accordance with the sound channel information set acquired by the data interface 9011 specifically includes that:

the processor 9012 is specifically configured to play the first sound image in accordance with the first sound channel information set acquired by the data interface 9011; and

the processor 9012 is further specifically configured to play the second sound image in accordance with the second sound channel information set acquired by the data interface 9011.

Still further optionally, the first image corresponds to first image position information, the second image corresponds to second image position information, the first image position information corresponds to the first sound channel information set, and the second image position information corresponds to the second sound channel information set;

the processor 9012 is further configured to acquire a coincident sound channel information set according to the first sound channel information set and the second sound channel information set that are acquired by the processor 9012, where sound channel information in the coincident sound channel information set is included in both the first sound channel information set and the second sound channel information set; and

the processor 9012 is further configured to play the first sound image and the second sound image according to a preset rule and in accordance with the coincident sound channel information set acquired by the processor 9012.

Yet further optionally, the processor 9012 is further configured to acquire first sound image data and second sound image data, where the first sound image data corresponds to the first sound image, and the second sound image data corresponds to the second sound image;

the processor 9012 is further configured to mix the first sound image data and the second sound image data that are acquired by the processor 9012, to obtain coincident sound image data; and

the processor 9012 is specifically further configured to play the first sound image and the second sound image according to the coincident sound image data acquired by the processor 9012 and in accordance with the coincident sound channel information set acquired by the processor 9012.

Optionally, the processor 9012 is further configured to acquire a first differentiating sound channel information set according to the first sound channel information set and the second sound channel information set, where the at least one piece of first sound channel information includes the first differentiating sound channel information set, and the at least one piece of second sound channel information does not include any first differentiating sound channel information in the first differentiating sound channel information set; and

the processor 9012 is further configured to play the first sound image in accordance with the first differentiating sound channel information set acquired by the processor 9012.

Optionally, the sound image play apparatus further includes at least one loudspeaker, where each loudspeaker in the at least one loudspeaker corresponds to one sound channel in the at least one sound channel; and

that the processor 9012 is configured to play a sound image in accordance with the sound channel information set acquired by the processor 9012 specifically includes that:

the processor 9012 is configured to drive, in accordance with the sound channel information set acquired by the processor 9012, the at least one loudspeaker to play the sound image.

According to the sound image play apparatus provided in this embodiment of the present invention, image position information may be acquired, and a sound channel information set may be acquired in accordance with a preset rule and according to the image position information, so as to play a sound image in accordance with the sound channel information set, where the image position information may be used to indicate a spatial position, which is in a first frame picture, of an image corresponding to the image position information, the sound channel information set may include at least one piece of sound channel information, the sound channel information corresponds to one sound channel, and the sound image corresponds to the image. Such a solution is simple, and does not need a complex mechanical structure and technical solution, and a sound channel information set may be acquired in a manner of acquiring image position information, so that a sound image can be played in a common sound channel manner, and therefore original stereo effects of any quantity of sound images corresponding to an image can be reproduced without requiring audio information to carry sound image position information. This solution may be used to play any audio and video file, and therefore, the present invention is beneficial for technology promotion.

With descriptions of the foregoing embodiments, a person skilled in the art may clearly understand that the present invention may be implemented by hardware, firmware or a combination thereof. When the present invention is implemented by software, the foregoing functions may be stored in a computer-readable medium or transmitted as one or more instructions or code in the computer-readable medium. The computer-readable medium may include a computer storage medium and a communications medium, where the communications medium may include any medium that enables a computer program to be transmitted from one place to another. The storage medium may be any available medium accessible to a computer. Examples of the computer-readable medium include but are not limited to: a RAM (Random Access Memory, random access memory), a ROM (Read-Only Memory, read-only memory), an EEPROM (Electrically Erasable Programmable Read-Only Memory, electrically erasable programmable read-only memory), a CD-ROM (Compact Disc Read-Only Memory, compact disc read-only memory) or other optical disk storage, a disk storage medium or other disk storage, or any other medium that can be used to carry or store expected program code in a command or data structure form and can be accessed by a computer. In addition, any connection may be appropriately defined as a computer-readable medium. For example, if software is transmitted from a website, a server or another remote source by using a coaxial cable, an optical fiber/cable, a twisted pair, a DSL (Digital Subscriber Line, digital subscriber line) or wireless technologies such as infrared ray, radio and microwave, the coaxial cable, optical fiber/cable, twisted pair, DSL or wireless technologies such as infrared ray, radio and microwave are included in fixation of a medium to which they belong. For example, a disk and disc used by the present invention includes a CD (Compact Disc, compact disc), a laser disc, an optical disc, a DVD (Digital Versatile Disc, digital versatile disc), a floppy disk and a Blue-ray disc, where the disk generally copies data by a magnetic means, and the disc copies data optically by a laser means. The foregoing combination should also be included in the protection scope of the computer-readable medium.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A sound image play method, comprising:
acquiring image position information, wherein the image position information corresponds to one image in at least one image, and the image position information is used to indicate a spatial position, which is in a first frame picture, of the image corresponding to the image position information;
acquiring a sound channel information set according to the image position information, wherein the sound channel information set comprises at least one piece of sound channel information, each piece of sound channel information in the at least one piece of sound channel information corresponds to one sound channel in at least one sound channel, and the sound channel information set corresponds to the image position information; and
playing a sound image in accordance with the sound channel information set, wherein the sound image corresponds to the image.

2. The method according to claim 1, wherein before the acquiring image position information, the method further comprises:
acquiring first frame picture data of the first frame picture; and
the acquiring image position information specifically comprises:
identifying the image position information from the first frame picture according to the first frame picture data.

3. The method according to claim 1, wherein before the playing a sound image in accordance with the sound channel information set, the method further comprises:
acquiring sound image data of the sound image; and
the playing a sound image in accordance with the sound channel information set specifically comprises:
playing the sound image according to the sound image data and in accordance with the sound channel information set.

4. The method according to claim 3, wherein before the acquiring sound image data of the sound image, the method further comprises:
acquiring first frame audio data of a first frame audio, wherein the first frame audio corresponds to the first frame picture; and
the acquiring sound image data of the sound image specifically comprises:
identifying the sound image data of the sound image from the first frame audio data.

5. The method according to claim 3, wherein the first frame picture comprise at least two images, and the at least two images comprise a first image and a second image, wherein the first image corresponds to a first sound image, and the second image corresponds to a second sound image; and
the playing a sound image in accordance with the sound channel information set specifically comprises:
playing the first sound image in accordance with the first sound channel information set; and
playing the second sound image in accordance with the second sound channel information set.

6. The method according to claim 5, wherein the first image corresponds to first image position information, the second image corresponds to second image position information, the first image position information corresponds to the first sound channel information set, and the second image position information corresponds to the second sound channel information set; and
the playing a sound image in accordance with the sound channel information set specifically comprises:
acquiring a coincident sound channel information set according to the first sound channel information set and the second sound channel information set, wherein sound channel information in the coincident sound channel information set is comprised in both the first sound channel information set and the second sound channel information set; and
playing the first sound image and the second sound image according to a preset rule and in accordance with the coincident sound channel information set.

7. The method according to claim 6, wherein before the playing the first sound image and the second sound image according to a preset rule and in accordance with the coincident sound channel information set, the method further comprises:
acquiring first sound image data and second sound image data, wherein the first sound image data corresponds to the first sound image, and the second sound image data corresponds to the second sound image; and
mixing the first sound image data and the second sound image data, to obtain coincident sound image data; and
the playing the first sound image and the second sound image according to a preset rule and in accordance with the coincident sound channel information set specifically comprises:
playing the first sound image and the second sound image according to the coincident sound image data and in accordance with the coincident sound channel information set.

8. The method according to claim 5, wherein before the playing the first sound image in accordance with the first sound channel information set, the method further comprises:
acquiring a first differentiating sound channel information set according to the first sound channel information set and the second sound channel information set, wherein sound channel information in the first differentiating sound channel information set is comprised in the first sound channel information set but is not comprised in the second sound channel information set; and
the playing the first sound image in accordance with the first sound channel information set specifically comprises:
playing the first sound image in accordance with the first differentiating sound channel information set.

9. The method according to claim 1, wherein the method is applied to a sound image play apparatus, and the sound image play apparatus comprises at least one loudspeaker, wherein each loudspeaker in the at least one loudspeaker corresponds to one sound channel in the at least one sound channel; and
the playing a sound image in accordance with the sound channel information set specifically comprises:
driving, in accordance with the sound channel information set, the at least one loudspeaker to play the sound image.

10. A sound image play apparatus, comprising:
an acquiring unit, configured to acquire image position information, wherein the image position information corresponds to one image in at least one image, and the image position information is used to indicate a spatial position, which is in a first frame picture, of the image corresponding to the image position information;
a channel unit, configured to acquire a sound channel information set according to the image position information acquired by the acquiring unit, wherein the sound channel information set comprises at least one piece of sound channel information, each piece of sound channel information in the at least one piece of sound channel information corresponds to one sound channel in at least one sound channel, and the sound channel information set corresponds to the image position information; and
a play unit, configured to play a sound image in accordance with the sound channel information set acquired by the channel unit, wherein the sound image corresponds to the image.

11. The apparatus according to claim 10, wherein the acquiring unit is further configured to acquire first frame picture data of the first frame picture; and
that the acquiring unit is configured to acquire image position information specifically comprises:
the acquiring unit is configured to identify the image position information from the first frame picture according to the first frame picture data acquired by the acquiring unit.

12. The apparatus according to claim 10, wherein the acquiring unit is further configured to acquire sound image data of the sound image; and
that the play unit is configured to play a sound image in accordance with the sound channel information set acquired by the channel unit specifically comprises that:
the play unit is configured to play the sound image according to the sound image data acquired by the acquiring unit and in accordance with the sound channel information set.

13. The apparatus according to claim 12, wherein the acquiring unit is further configured to acquire first frame audio data of a first frame audio, wherein the first frame audio corresponds to the first frame picture; and
that the acquiring unit is further configured to acquire sound image data of the sound image specifically comprises that:
the acquiring unit is configured to identify the sound image data of the sound image from the first frame audio data acquired by the acquiring unit.

14. The apparatus according to claim 12, wherein the first frame picture comprise at least two images, and the at least two images comprise a first image and a second image, wherein the first image corresponds to a first sound image, and the second image corresponds to a second sound image; and
that the play unit is configured to play a sound image in accordance with the sound channel information set acquired by the acquiring unit specifically comprises that:
the play unit is specifically configured to play the first sound image in accordance with the first sound channel information set acquired by the acquiring unit; and
the play unit is further specifically configured to play the second sound image in accordance with the second sound channel information set acquired by the acquiring unit.

15. The apparatus according to claim 14, wherein the first image corresponds to first image position information, the second image corresponds to second image position information, the first image position information corresponds to the first sound channel information set, and the second image position information corresponds to the second sound channel information set; and
the play unit comprises:
a coincident channel subunit, configured to acquire a coincident sound channel information set according to the first sound channel information set and the second sound channel information set that are acquired by the channel unit, wherein sound channel information in the coincident sound channel information set is comprised in both the first sound channel information set and the second sound channel information set; and
a coincident play subunit, configured to play the first sound image and the second sound image according to a preset rule and in accordance with the coincident sound channel information set acquired by the coincident channel subunit.

16. The apparatus according to claim 15, wherein the play unit further comprises:
an acquiring subunit, configured to acquire first sound image data and second sound image data, wherein the first sound image data corresponds to the first sound image, and the second sound image data corresponds to the second sound image; and
a mixing subunit, configured to mix the first sound image data and the second sound image data that are acquired by the acquiring subunit, to obtain coincident sound image data; and
the coincident play subunit is specifically configured to play the first sound image and the second sound image according to the coincident sound image data acquired by the mixing subunit and in accordance with the coincident sound channel information set acquired by the coincident channel subunit.

17. The apparatus according to claim 14, wherein the play unit further comprises:
a differentiating channel subunit, configured to acquire a first differentiating sound channel information set according to the first sound channel information set and the second sound channel information set, wherein sound channel information in the first differentiating sound channel information set is comprised in the first sound channel information set but is not comprised in the second sound channel information set; and
a differentiating play subunit, configured to play the first sound image in accordance with the first differentiating sound channel information set acquired by the differentiating channel subunit.

18. The apparatus according to claim 10, wherein the sound image play apparatus further comprises at least one loudspeaker, wherein each loudspeaker in the at least one loudspeaker corresponds to one sound channel in the at least one sound channel; and
that the play unit is configured to play a sound image in accordance with the sound channel information set acquired by the channel unit specifically comprises that:
the play unit is configured to drive, in accordance with the sound channel information set acquired by the channel unit, the at least one loudspeaker to play the sound image.
